(19) United States
(12) Patent Application Publication
(10) Pub. No.: US 2024/0401454 A1
(43) Pub. Date: Dec. 5, 2024

(54) WATER INJECTION MANAGEMENT AND OPTIMIZATION UTILIZING ARTIFICIAL NEURAL NETWORK

(71) Applicant: SAUDI ARABIAN OIL COMPANY, Dhahran (SA)

(72) Inventors: Reem M. ALBESHRI, Dhahran (SA); Jibran AYUB, Dhahran (SA)

(73) Assignee: SAUDI ARABIAN OIL COMPANY, Dhahran (SA)

(21) Appl. No.: 18/329,174

(22) Filed: Jun. 5, 2023

(51) Int. Cl. E21B 43/267; E21B 43/20

(52) U.S. Cl. CPC E21B 43/267; E21B 43/20; G06N 3/084

(57) ABSTRACT

Systems and methods for well field optimization are described. A system includes a well injection planner coupled to a machine learning (ML) engine. A computer-readable memory stores a trained model, input data, and predictive results data. The well injection planner is implemented on at least one processor and is configured to provide the trained model and the input data to an inference stage of the ML engine and to receive the predictive results data output from the inference stage. The input data includes at least water injection rate and voidage replacement data for a well field and the output predictive results data includes a cumulative oil production forecast result for the well field.

### FIELD OF THE DISCLOSURE

The present disclosure relates generally to petroleum well field development and, more particularly, to well field injection and reservoir performance design.

### BACKGROUND OF THE DISCLOSURE

Petroleum well fields can have a large number of well sites. Each well site can have a well that requires injection of water and other fluids to carry out drilling and other well operations. Reservoirs are used to store water and other fluids. The number and capacity of reservoirs needed to support water injection in wells across a well field are important design factors.

Well injections optimization is a key decision in the well field development process. When several injectors are planned, hundreds of water rate and voidage replacement options must be considered in order to optimize hydrocarbon production based on a complex combination of geological, petrophysical, flow regimen, and economical parameters. This complexity makes it hard to grasp intuitively by engineers in the field using manual techniques. Conventional automatic approaches to well injection optimizations rely on numerical reservoir simulators. However, running such numerical reservoir simulators has a prohibitive computational cost and delay because thousands of potential cases often must be run using numerical reservoir simulators and each of these runs takes on the order of hours to complete.

One conventional approach is a hybrid of manual judgment and automatic simulation use. However, this hybrid approach is also computationally expensive and slow as it requires an understanding of the impact of different influencing engineering and geological parameters which are confirmed by a number of reservoir simulation iterations. Also reservoir performance is influenced by nonlinearly correlated parameters, which may also evolve with time—outstripping the ability of engineers or out-of-date numerical reservoir simulators. Hence, conventional manual or hybrid approaches using professional judgement, in general, fail to predict the best water injection optimization.

What is needed are computer-implemented methods and systems that can assist engineers to find an efficient development plan that will yield maximum productivities as well as increased effectiveness of well site recovery factors. Further, computer-implemented methods and systems are needed that that allow engineers to predict and optimize water well injectors performance and production without the need to depend solely on numerical reservoir simulation.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one embodiment, a system for well field optimization includes a well injection planner coupled to a machine learning (ML) engine. A computer-readable memory, coupled to the well injection planner, is configured to store a trained model, input data, and predictive results data. The well injection planner is implemented on at least one processor and is configured to provide the trained model and the input data to an inference stage of the ML engine and to receive the predictive results data output from the inference stage.

In one feature, the input data includes at least water injection rate and voidage replacement data for a well field and the output predictive results data includes a cumulative oil production forecast result for the well field.

In another feature, the voidage replacement data is a voidage replacement ratio between a volume of injected fluid and a volume of produced fluid for a reservoir in the well field.

In a further feature, the predictive results output from the inference stage of the ML engine are compared with numeric simulator results to obtain a confirmation of the accuracy of the predictive cumulative oil field forecast.

In another embodiment, a computer-implemented method for well field optimization using a machine learning (ML) engine is provided. The method includes steps of storing training data in computer-readable memory, and applying, with at least one processor, the stored training data to a training stage of the ML engine to obtain a trained model. The method further includes the step of applying, with at least one processor, input data for water injection to the inference stage of the ML engine to obtain predictive results data according to the trained model.

In another embodiment, a computer program product device having a non-transitory computer-readable memory with instructions executable by at least one processor to perform operations for well field optimization using a machine learning (ML) engine is provided.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a system for well field optimization according to an embodiment of the present invention.

FIG. 2 is a diagram of a computer-implemented method for well injection planning according to an embodiment of the present invention.

FIG. 3 is a diagram illustrating layers in an artificial neural network model according to one embodiment.

FIG. 4 is a diagram illustrating an example computing device that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to petroleum well field development and, more particularly, to well field injection and reservoir performance design.

“Petroleum” as used herein refers to hydrocarbons, including crude oil, natural gas liquids, natural gas and their products.

### Well Field Optimization and Planning

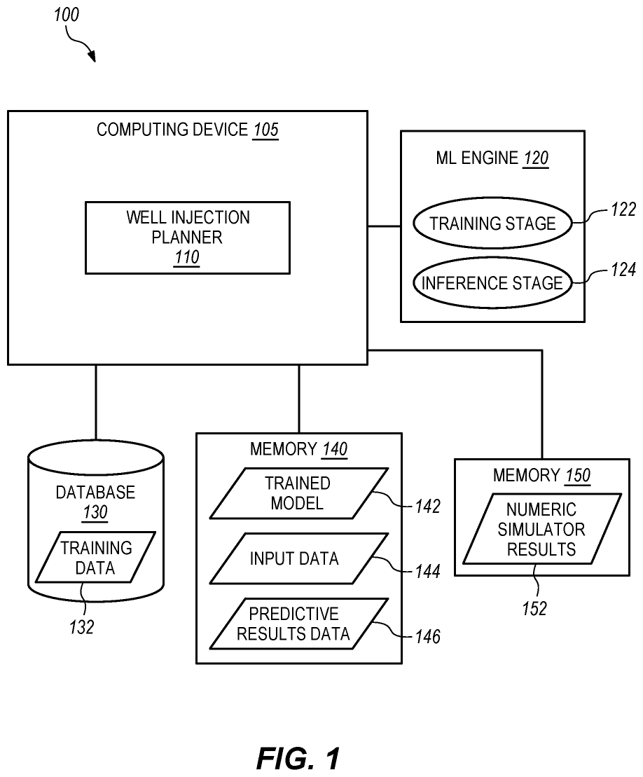

FIG. 1 is a diagram of a system for well field optimization 100 according to an embodiment of the present invention. As shown in FIG. 1, system 100 includes a computing device 105 having a well injection planner 110 coupled to a machine learning (ML) engine 120. ML engine 120 has a training stage 122 and an inference stage 124.

System 100 further includes a database 130 and computer-readable memory devices 140 and 150. Database 130 stores training data 132. Computer-readable memory 140 stores a trained model 142, input data 144, and predictive results data 146. Database 130 is coupled to well field planner 110 and stores training data 132.

In one feature, input data 144 includes at least water injection rate and voidage replacement data for a well field and the output predictive results data includes a cumulative oil production forecast result for the well field. Likewise training data 132 also includes at least water injection rate and voidage replacement data for a well field and the output predictive results data includes a cumulative oil production forecast result for the well field. In one example, the voidage replacement data is a voidage replacement ratio between a volume of injected fluid and a volume of produced fluid for a reservoir in the well field.

During operation, well injection planner 110 provides trained model 142 and input data 144 to inference stage 124 of ML engine 120 for processing and receives predictive results data 146 output from the inference stage 124 of ML engine 120.

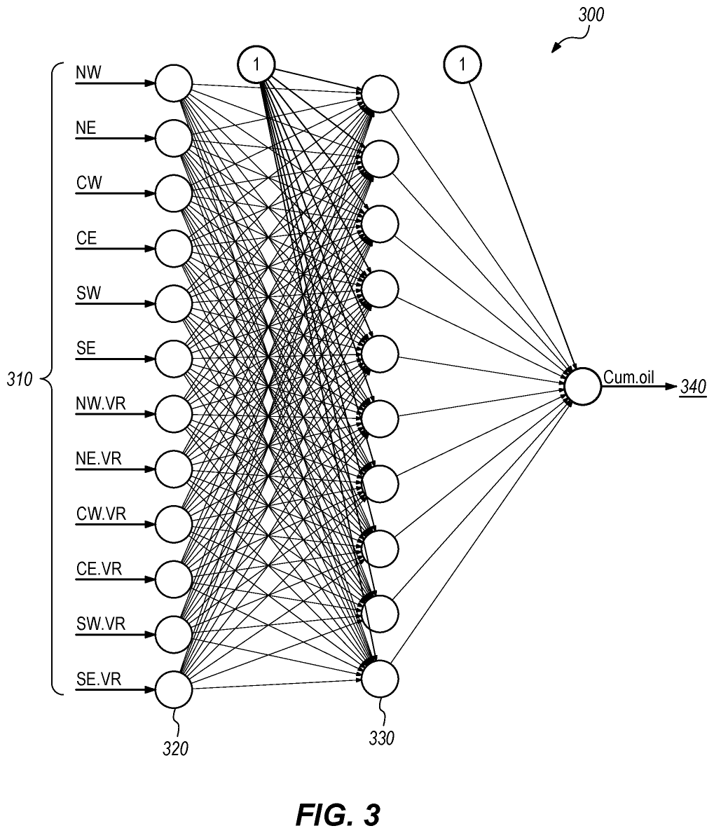

During training, well-injection planner 110 provides training data 132 to training stage 122 of ML engine 120 to obtain trained model 142. Well-injection planner 110 then stores trained model 142 in computer-readable memory 140. In one example, trained model 142 is an artificial neural network (ANN) model. For example, the trained ANN model may include multiple hidden layers, as described further below with respect to FIG. 3, and includes a resilient backprograpation algorithm. Further, training stage 122 of ML engine 120 may process training data 132 in multiple repetitions starting with an initial ANN model and for each successive repetition use weight inputs obtained from a prior pass as parameters to the ANN model until a number of repetitions are performed and a final trained model 142 is obtained and output for storage.

In a further embodiment, numeric simulator results 152 are also available and stored in a memory 150. Well injection planner 110 may compare predictive results data 146 output from inference stage 124 of ML engine 120 with the numeric simulator results 152 to obtain a confirmation of the accuracy of the predictive cumulative oil field forecast.

In example implementations, well injection planner 110 may be implemented in software, firmware, hardware or any combination thereof. Computing device 105 may be any computing device having at least one processor and computer-readable memory. Database 130 may be any type of database and database manage system including but not limited to a relational database. Memory 140 and memory 150 may be any type of non-transitory computer-readable readable medium. These examples are illustrative and not intended to be limiting. For example, all of the data in FIG. 1 may be stored in the same or different computer-readable memory or databases on the same of different computing devices or other data storage devices.

### Operation

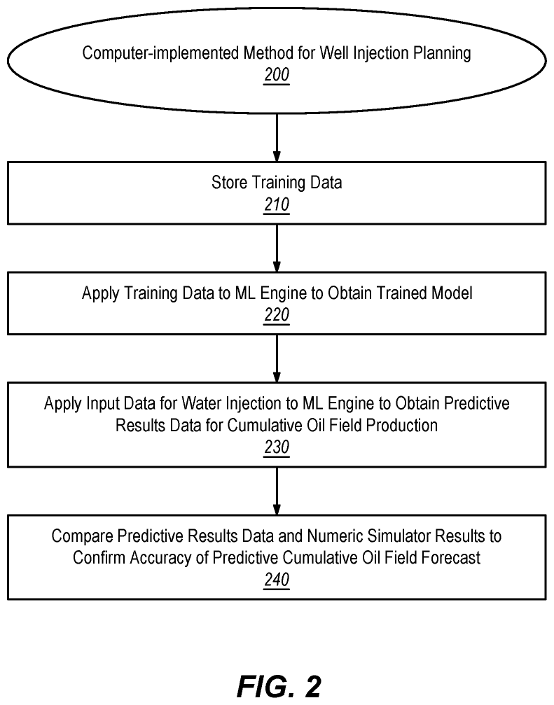

For brevity, the operation of system 100 and its components is described in further detail below with respect to method 200 (FIG. 2) and ANN model 300 (FIG. 3). Method 200 is not intended however to be limited to the embodiment of system 100. FIG. 2 is a diagram of a computer-implemented method for well injection planning 200 according to an embodiment of the present invention (steps 210-240). FIG. 3 is a diagram illustrating layers in an artificial neural network model 300 according to one embodiment.

In step 210, training data is stored. For example, training data 132 may be stored in database 130. For example, a user may load training data 132 for storage in database 130 using computing device 105 or other input means to database 130. In one feature, training data 132 includes at least water injection rate and voidage replacement data for a well field and a cumulative oil production forecast result for the well field. In one example, the voidage replacement data is a voidage replacement ratio between a volume of injected fluid and a volume of produced fluid for a reservoir in the well field.

Training data 132 may have multiple records (or rows) of input data corresponding to values of different parameters in particular scenarios related to well field optimization as well as their associated labels. For example as shown in FIG. 3, each record (or row) in training data 132 may have number of values 310 for different parameters for a well field scenario. These parameters may include six water injection rate parameters (NW, NE, CW, CE, SW, SE) and six voidage replacement parameters (NW.VR, NE.VR, CW.VR, CE.VR, SW.VR, and SE.VR) for water injector wells in a well field. Each single water well injector has two parameters (water injection rate and voidage replacement rate). The output which is the (CUM OIL) is the cumulative oil production for an oil wells field.

An associated label 340 may also be included in each record (or row) of training data 132. This label may be a cumulative oil production forecast result (CUM. OIL) for the well field associated with the respective parameters for the particular oil field scenario.

In embodiments, water injection rate and voidage replacement may be applied per single well or per region in the field or per the whole field level. In this way, different parameters may be input per well or per field or per regions in field.

In one example implementation, inventors applied the parameters input (water injection rate and water voidage replacement) per each region in the field. As shown in FIG. 3, the regions in a field were set to 6 regions of an oil well field based on a certain criteria such as connectivity or communication. The parameter NW is the water injection rate input for a first NW region, and NW.VR is the voidage replacement parameter input for the NW region in the field. Similar parameters are input as water injection rate inputs (NE, CW, CE, SW, SE) and voidage replacement inputs (NE.VR, CW.VR, CE.VR, SW.VR, SE.VR) for the other respective regions in the field. The output result, Cum_oil, is the cumulative oil result for the field. So each region in the well field get an input of both water injection rate and voidage replacement and based on model 300 outputs an output field cumulative oil result.

In step 220, control proceeds to apply training data to a ML engine to obtain a trained model. For example, well field planner 110 can apply training data 132 to a training stage 122 of ML engine 124 to obtain a trained model 142. In one embodiment, trained model 142 is an ANN model 300 as shown in FIG. 3. ANN model 300 has one or more hidden layers between input layer 320 and output layer 330 and includes a resilient backpropagation algorithm.

During training, training stage 122 processes the training data in multiple repetitions starting with an initial ANN model 300 and for each successive repetition using weight inputs obtained from a prior pass as parameters to the ANN model until a number of repetitions are performed and a final trained model 142 is obtained. In one example, 20 hidden layers were used. Weight was set to null at initialization and repetition set to 15. So the ANN model in each repetition will take the weight input from the previous repetition. Parameters (“rep” parameters) allow the training stage to repeat the training. In one example, a neural net in R programming language, such as, a deep neural network may be used.

For example, each record (or row) in training data 132 may be passed to training stage 122. An input array 310 of values for different parameters for a well field scenario associated with the record are passed to nodes of input layer 320 of ANN model 300. Nodes of input layer 320 are in turn coupled to one or more hidden layers for further processing according to ANN model 300. Then an output array of values are output from nodes of an output layer 330. The output array values are further processed to obtain a final label 340. In the case where values in input array 310 are for six water injection rate parameters (NW, NE, CW, CE, SW, SE) and six voidage replacement parameters (NW.VR, NE.VR, CW.VR, CE.VR, SW.VR, and SE.VR), the associated label 340 may be a cumulative oil production forecast result (CUM.OIL) for a respective well field scenario. Training stage 122 may continue to process other records (or rows) in training data to obtain a final trained model 142. This final trained model 142 for example may be the ANN model that minimizes a loss function or meets other training criteria.

After training, in step 230, control proceeds to apply input data for water injection to an ML engine to obtain predictive results data, such as, a cumulative oil field production forecast, according to the trained model. For example, an input array 310 of values for water injection including water injection rate and voidage replacement data for a well field scenario being evaluated is passed to as input data 144 to inference stage 124 which applies the trained model 142. As shown in FIG. 3, the trained model is a trained ANN model 300 and passes the input array of values 310 to nodes of an input layer 320, then through one or more hidden layers, to nodes of output layer 330 for further processing to obtain an output predictive results data label value 340 representative of a predictive cumulative oil production forecast result (Cum. Oil) for the well field scenario being optimized and planned.

The output predictive results data label value 340 may then be output for storage, display, or transmission over a data network. For example, output label value 340 may be output for storage as predictive result data 146 in computer-readable memory 146.

In step 240, control proceeds to compare the predictive results data 146 output from inference stage 124 of ML engine 120 and stored in the computer readable memory 140 with numeric simulator results 152 to obtain a confirmation of the accuracy of the predictive cumulative oil field forecast.

### Example Test Results

In tests, the inventors tested a trained ANN model using data as described above. A comparison of the predictive cumulative oil field forecast obtained with results from reservoir simulation indicated the accuracy of the forecasting was over 85%.

### Advantages

Conventional numeric simulations are computationally expensive and time consuming on the order of days and hours. One typical convention workflow requires an engineer to choose multiple random parameters for water rate and voidage replacement according to a complex reservoir model and run different scenarios using numerical reservoir simulation to forecast the field production performance.

In contrast, an advantage of certain embodiments in the present disclosure is instead of running multiple scenarios, an engineer can simply go through one step which is basically provide all possible input/parameters at once to well field planner 110 and then by accessing a trained ANN model and ML engine will forecast field performance in few minutes or less without even using numerical reservoir simulation.

### Further Computer-Implemented Embodiments

Computing device 105 can be any type of computing device including, but not limited to, a smartphone, laptop, desktop, tablet, workstation, kiosk or other computing device having at least one processor and a non-transitory computable readable memory. Computing device 105 may include a browser, application, and operating system along with a user-interface depending upon a desired configuration. ML engine 120 may also be implemented on computing device 105 or other remote computing devices at the same or different locations.

Computing device 105 may have functionality performed at the same or different physical locations and by one or more processors located at the same or different locations. Computing device 105 many also be coupled to over a network interface to remote computing devices to perform aspects of the functionality described herein. For example, computing device 105 may communicate with a remote computing device or platform having a library or other functionality to implement ML engine 120 and perform the machine learning operations as described herein. For example, well injection planner 110 may place a function call, API request, or other request to a remote ML engine 120.

Computing functionality as described herein may also be implemented on a server, cluster of servers, web server, cloud-computing platform and/or other remote service. A client/server architecture may also be implemented as would be apparent to a person skill in the art given this description.

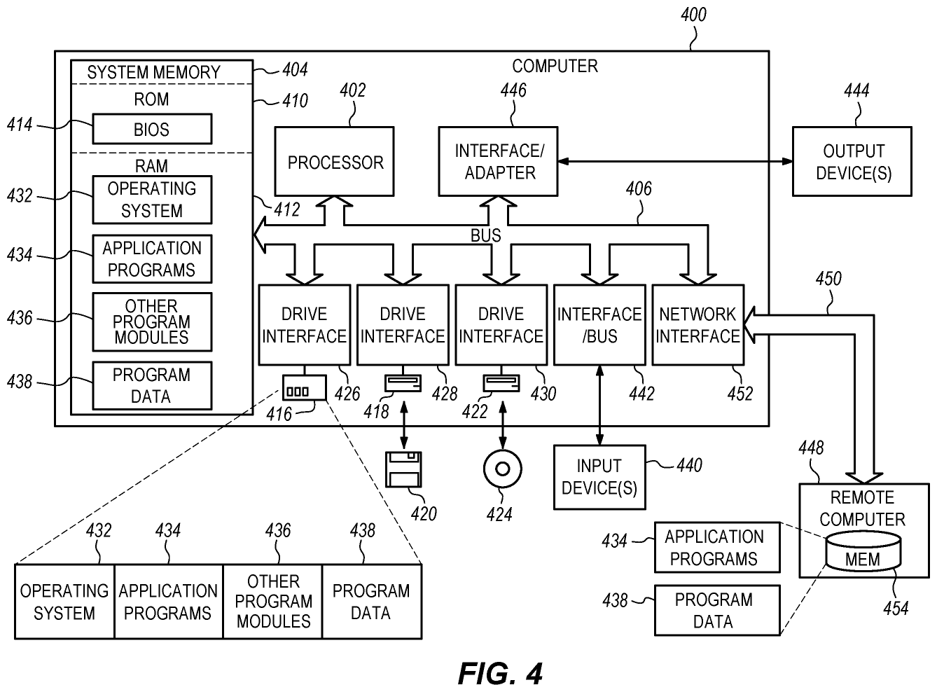

In further embodiments, computing device 105 and method 200 may also be implemented on example computing device 400 shown in FIG. 4. While, for purposes of simplicity of explanation, the example method of FIG. 2 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard. FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a smartphone, personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM. SDRAM, Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures or other or communication infrastructure. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include well field planner 110 can include data generated or provided to perform method 200. The application programs 434 and program data 438 can include functions and methods programmed to perform processor-implemented functions and control as described herein with respect system 100, and in particular well field planner 110, and method 200 including steps 210-240, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to view a display on display device 226. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 300, or portions thereof, may be stored in a remote memory storage device 454.

Embodiment A disclosed herein includes system having a well injection planner implemented on at least one processor, wherein the well-injection planner is coupled to a machine learning (ML) engine having a training stage and an inference stage; and computer-readable memory configured to store a trained model, input data for the inference stage of the ML engine and predictive results data output from the inference stage of the ML engine; wherein the well injection planner is configured to provide the trained model and the input data to the inference stage of the ML engine and to receive the predictive results data output from the inference stage of the ML engine, and wherein the input data includes at least water injection rate and voidage replacement data for a well field and the output predictive results data includes a cumulative oil production forecast result for the well field.

Embodiment A may have one or more of the following additional elements in any combination or all the elements in a combination: Element A1: a database configured to store training data, and wherein the well-injection planner is further configured to provide the training data to the training stage of the ML engine to obtain the trained model. Element A2: the trained model has an artificial neural network model. Element A3: the trained artificial neural network model has multiple hidden layers and includes a resilient backprograpation algorithm. Element A4: the training stage of the ML engine processes the training data in multiple repetitions starting with an initial artificial neural network model and for each successive repetition uses weight inputs obtained from a prior pass as parameters to the artificial neural network model until a number of repetitions are performed and a final trained model is obtained. Element A5: the voidage replacement data comprises a voidage replacement ratio between a volume of injected fluid and a volume of produced fluid for a reservoir in the well field. Element A6: the well injection planner is further configured to compare the predictive results output from the inference stage of the ML engine and stored in the computer readable memory with numeric simulator results to obtain a confirmation of the accuracy of the predictive cumulative oil filed forecast. Element A7: the input data for water injection includes at least water injection rate and voidage replacement data for a well field applied per single well or per region in the field or per the whole field level.

Embodiment B disclosed herein includes a computer-implemented method for well field optimization using a machine learning (ML) engine having a training stage and an inference stage, comprising: storing training data in computer-readable memory; applying, with at least one processor, the stored training data to the training stage of the ML engine to obtain a trained model; and applying, with at least one processor, input data for water injection to the inference stage of the ML engine to obtain predictive results data according to the trained model, wherein the input data for water injection includes at least water injection rate and voidage replacement data for each water well injector of a well field and the output predictive results data includes a cumulative oil production forecast result for the well field.

Embodiment B may have one or more of the following additional elements in any combination or all the elements in a combination: Element B1: the trained model comprises an artificial neural network. Element B2: wherein the trained artificial neural network model has multiple hidden layers and includes a resilient backprograpation algorithm. Element B3: the step of processing the training data in multiple repetitions in the training stage of the ML engine starting with an initial artificial neural network model and for each successive repetition using weight inputs obtained from a prior pass as parameters to the artificial neural network model until a number of repetitions are performed and a final trained model is obtained. Element B4: wherein the voidage replacement data comprises a voidage replacement ratio between a volume of injected fluid and a volume of produced fluid for a reservoir in the well field, and the applying input data step includes applying the water injection rate and the voidage replacement ratio for the well field to the inference stage of the ML engine. Element B5: comparing the predictive results output from the inference stage of the ML engine and stored in the computer readable memory with numeric simulator results to obtain a confirmation of the accuracy of the predictive cumulative oil filed forecast. Element B6: the input data for water injection includes at least water injection rate and voidage replacement data for each water well injector of a well field applied per single well or per region in the field or per the whole field level.

Embodiment C disclosed herein includes a computer program product device comprising: non-transitory computer-readable memory having instructions executable by at least one processor to perform the following operations for well field optimization using a machine learning (ML) engine having a training stage and an inference stage: applying, with the at least one processor, training data to the training stage of the ML engine to obtain a trained model; applying, with the at least one processor, input data for water injection to the inference stage of the ML engine to obtain predictive results data according to the trained model, wherein the input data for water injection includes at least water injection rate and voidage replacement data for a well field and the output predictive results data includes a cumulative oil production forecast result for the well field; and receiving the output predictive results data from the ML engine for storage, display or transmission over a data network.

Embodiment C may have one or more of the following additional elements in any combination or all the elements in a combination: Element C1: the voidage replacement data comprises a voidage replacement ratio between a volume of injected fluid and a volume of produced fluid for a reservoir in the well field, and the applying input data operation includes applying the water injection rate and the voidage replacement ratio for the well field to the inference stage of the ML engine. Element C2: the operations further comprise electronically comparing the predictive results output from the inference stage of the ML engine and stored in the computer readable memory with numeric simulator results to obtain a confirmation of the accuracy of the predictive cumulative oil field forecast. Element C3: the trained model comprises an artificial neural network model having multiple hidden layers and includes a resilient backprograpation algorithm. Element C4: the input data for water injection includes at least water injection rate and voidage replacement data for each water well injector of a well field applied per single well or per region in the field or per the whole field level.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,”, “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system, comprising:
a well injection planner implemented on at least one processor, wherein the well-injection planner is coupled to a machine learning (ML) engine having a training stage and an inference stage; and
computer-readable memory configured to store a trained model, input data for the inference stage of the ML engine and predictive results data output from the inference stage of the ML engine;
wherein the well injection planner is configured to provide the trained model and the input data to the inference stage of the ML engine and to receive the predictive results data output from the inference stage of the ML engine, and
wherein the input data includes at least water injection rate and voidage replacement data for a well field and the output predictive results data includes a cumulative oil production forecast result for the well field.

2. The system of claim 1, further comprising a database configured to store training data, and wherein the well-injection planner is further configured to provide the training data to the training stage of the ML engine to obtain the trained model.

3. The system of claim 2, wherein the trained model comprises an artificial neural network model.

4. The system of claim 3, wherein the trained artificial neural network model has multiple hidden layers and includes a resilient backprograpation algorithm.

5. The system of claim 4, wherein the training stage of the ML engine processes the training data in multiple repetitions starting with an initial artificial neural network model and for each successive repetition uses weight inputs obtained from a prior pass as parameters to the artificial neural network model until a number of repetitions are performed and a final trained model is obtained.

6. The system of claim 1, wherein the voidage replacement data comprises a voidage replacement ratio between a volume of injected fluid and a volume of produced fluid for a reservoir in the well field.

7. The system of claim 1, wherein the well injection planner is further configured to compare the predictive results output from the inference stage of the ML engine and stored in the computer readable memory with numeric simulator results to obtain a confirmation of the accuracy of the predictive cumulative oil filed forecast.

8. A computer-implemented method for well field optimization using a machine learning (ML) engine having a training stage and an inference stage, comprising:
storing training data in computer-readable memory;
applying, with at least one processor, the stored training data to the training stage of the ML engine to obtain a trained model; and
applying, with at least one processor, input data for water injection to the inference stage of the ML engine to obtain predictive results data according to the trained model, wherein the input data for water injection includes at least water injection rate and voidage replacement data for a well field and the output predictive results data includes a cumulative oil production forecast result for the well field.

9. The method of claim 8, wherein the trained model comprises an artificial neural network model.

10. The method of claim 9, wherein the trained artificial neural network model has multiple hidden layers and includes a resilient backprograpation algorithm.

11. The method of claim 10, further comprising the step of processing the training data in multiple repetitions in the training stage of the ML engine starting with an initial artificial neural network model and for each successive repetition using weight inputs obtained from a prior pass as parameters to the artificial neural network model until a number of repetitions are performed and a final trained model is obtained.

12. The method of claim 8, wherein the voidage replacement data comprises a voidage replacement ratio between a volume of injected fluid and a volume of produced fluid for a reservoir in the well field, and the applying input data step includes applying the water injection rate and the voidage replacement ratio for the well field to the inference stage of the ML engine.

13. The method of claim 8, further comprising comparing the predictive results output from the inference stage of the ML engine and stored in the computer readable memory with numeric simulator results to obtain a confirmation of the accuracy of the predictive cumulative oil filed forecast.

14. A computer program product device comprising:
non-transitory computer-readable memory having instructions executable by at least one processor to perform the following operations for well field optimization using a machine learning (ML) engine having a training stage and an inference stage:
applying, with the at least one processor, training data to the training stage of the ML engine to obtain a trained model;
applying, with the at least one processor, input data for water injection to the inference stage of the ML engine to obtain predictive results data according to the trained model, wherein the input data for water injection includes at least water injection rate and voidage replacement data for a well field and the output predictive results data includes a cumulative oil production forecast result for the well field; and
receiving the output predictive results data from the ML engine for storage, display or transmission over a data network.

15. The computer program product device of claim 14, wherein the voidage replacement data comprises a voidage replacement ratio between a volume of injected fluid and a volume of produced fluid for a reservoir in the well field, and the applying input data operation includes applying the water injection rate and the voidage replacement ratio for the well field to the inference stage of the ML engine.

16. The computer program product device of claim 14, wherein the operations further comprise electronically comparing the predictive results output from the inference stage of the ML engine and stored in the computer readable memory with numeric simulator results to obtain a confirmation of the accuracy of the predictive cumulative oil field forecast.

17. The computer program product device of claim 14, wherein the trained model comprises an artificial neural network model having multiple hidden layers and includes a resilient backprograpation algorithm.

18. The system of claim 1, wherein the input data for water injection includes at least water injection rate and voidage replacement data for each water well injector of a well field applied per single well, per region in the field, or per the whole field level.

19. The method of claim 8, wherein the input data for water injection includes at least water injection rate and voidage replacement data for each water well injector of a well field applied per single well, per region in the field, or per the whole field level.

20. The computer program product device of claim 14, wherein the input data for water injection includes at least water injection rate and voidage replacement data for each water well injector of a well field applied per single well, per region in the field, or per the whole field level.
